(19) United States
(12) Patent Application Publication
(10) Pub. No.: US 2024/0053159 A1
(43) Pub. Date: Feb. 15, 2024

(54) GUIDANCE DEVICE, GUIDANCE METHOD, AND RECORDING MEDIUM

(71) Applicant: NEC Corporation, Minato-ku, Tokyo (JP)

(72) Inventor: Toshiyuki Tamura, Tokyo (JP)

(73) Assignee: NEC Corporation, Minato-ku, Tokyo (JP)

(21) Appl. No.: 17/766,329

(22) PCT Filed: Oct. 5, 2020
(86) PCT No.: PCT/JP2020/037683

§ 371 Date: Apr. 4, 2022

(30) Foreign Application Priority Data
Oct. 8, 2019 (JP) 2019-185117

(51) Int. Cl. G01C 21/34; G01C 21/30

(52) U.S. Cl. CPC G01C 21/3484; G01C 21/30

(57) ABSTRACT

A guidance device acquires sensing information pertaining to a surrounding environment of a user acquired from a wearable terminal worn on the user and generates guidance information pertaining to guidance for the user based on the sensing information and a type of disability of the user.

### TECHNICAL FIELD

The present invention relates to a guidance device, a guidance method, and a recording medium.

### BACKGROUND ART

A device that supports people with disabilities such as the visually impaired is sought after. Patent Document 1 discloses a technology that mounts a camera on the face of a visually impaired person, inputs images generated by the camera to a mobile terminal, reads steps, orange lines, white lines, and text from the images while the person walks, and outputs a voice guide for signal identification with the aim of expanding the range of activities of the visually impaired person even without a guide dog.

Patent Document 2 discloses a technology in which a visual assist device useful for assisting a visually impaired person includes an image sensor to recognize an object in image data acquired from the image sensor and generate speech signals on the basis of the reliability based on the classification of the object.

### PRIOR ART DOCUMENTS

### Patent Documents

Patent Document 1: Japanese Unexamined Patent Application, First Publication No. 2002-219142
Patent Document 2: Japanese Unexamined Patent Application, First Publication No. 2016-143060

### SUMMARY OF THE INVENTION

### Problem to be Solved by the Invention

In order to further expand the range of activities of people with disabilities, there is a demand for a device capable of guiding people with disabilities with higher accuracy. An example object of the present invention is to provide a guidance device, a guidance method, and a recording medium that solve the aforementioned problems.

### Means for Solving the Problem

According to the first example aspect of the present invention, a guidance device includes: an acquisition means for acquiring sensing information pertaining to a surrounding environment of a user, the sensing information being acquired from a wearable terminal worn on the user; a guidance information generation means for generating guidance information pertaining to guidance for the user based on the sensing information and a type of disability of the user; and an output means for outputting the guidance information.

According to the second example aspect of the present invention, a guidance device includes: an acquisition means for acquiring sensing information pertaining to a surrounding environment of a user, the sensing information being acquired from a wearable terminal worn on the user, the sensing information including at least a position of the user, an estimated recognition direction of the user, and a current image in the estimated recognition direction captured at the position of the user; a guidance information generation means for generating guidance information pertaining to guidance for the user based on the position of the user, the estimated recognition direction of the user, and the image; and an output means for outputting the guidance information.

According to the third example aspect of the present invention, a guidance method includes: acquiring sensing information pertaining to a surrounding environment of a user, the sensing information being acquired from a wearable terminal worn on the user; generating guidance information pertaining to guidance for the user based on the sensing information and a type of disability of the user; and outputting the guidance information.

According to the fourth example aspect of the present invention, a recording medium stores a program for causing a computer of a guidance device to execute: acquiring sensing information pertaining to a surrounding environment of a user, the sensing information being acquired from a wearable terminal worn on the user; generating guidance information pertaining to guidance for the user based on the sensing information and a type of disability of the user; and outputting the guidance information.

### Effect of Invention

According to an example embodiment of the present invention, it is possible to provide a guidance device capable of guiding people with disabilities with higher accuracy.

### BRIEF DESCRIPTION OF THE DRAWINGS

FIG. 1 is a diagram showing an outline of the guidance system according to an example embodiment of the present invention.

FIG. 2 is a diagram showing a hardware configuration of a wearable terminal according to the example embodiment of the present invention.

FIG. 3 is a diagram showing a hardware configuration of a guidance device, an external device, and a mobile terminal according to the example embodiment of the present invention.

FIG. 4 is a function block diagram of the guidance device according to the example embodiment of the present invention.

FIG. 5 is a diagram showing the processing flow of the guidance system according to the first example embodiment.

FIG. 6 is a diagram showing the processing flow of the guidance system according to the second example embodiment.

FIG. 7 is a diagram showing the processing flow of the guidance system according to the third example embodiment.

FIG. 8 is a diagram showing a guidance device according to another example embodiment of the present invention.

FIG. 9 is a diagram showing a first processing flow by the guidance device shown in FIG. 8.

FIG. 10 is a diagram showing a second processing flow by the guidance device shown in FIG. 8.

### EXAMPLE EMBODIMENT

Hereinbelow, the guidance system according to an example embodiment of the present invention will be described with reference to the drawings.

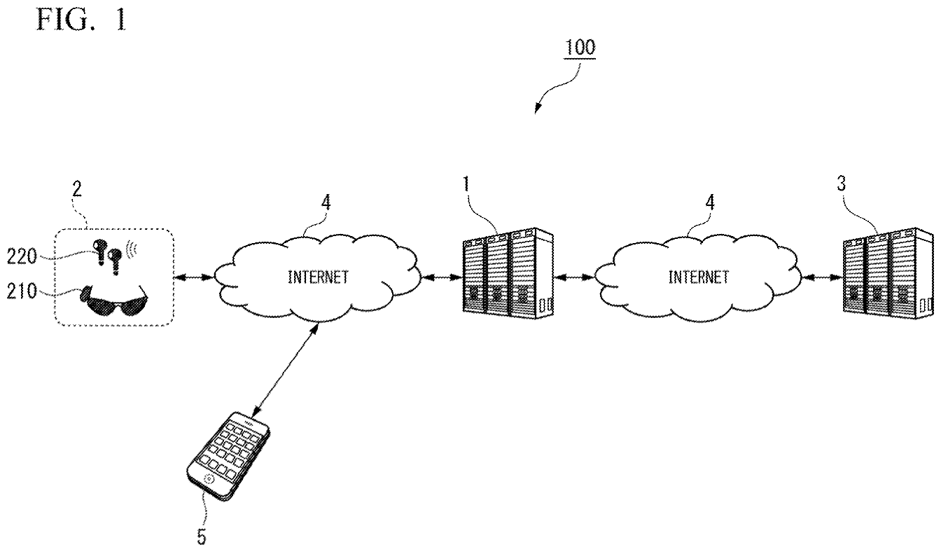

FIG. 1 is a diagram showing an outline of the guidance system.

As shown in FIG. 1, a guidance system 100 is configured by connecting at least a guidance device 1 and a wearable terminal 2 via a communication network such as the Internet 4. An external device 3 and a mobile terminal 5 are further connected to the guidance system 100 shown in FIG. 1. The external device 3 is connected to the guidance device 1 via a communication network such as the Internet 4. The mobile terminal 5 is also connected to the guidance device 1 via a communication network such as the Internet 4. The wearable terminal 2 is worn by a disabled person in this example embodiment. The mobile terminal 5 is carried by a family member of the disabled person, a caregiver of an organization that supports the disabled person, a school teacher, or the like. Alternatively, the mobile terminal 5 may be carried by the disabled person himself/herself. The external device 3 may be a device provided by an administrator different from the administrator who manages the guidance system 100 to provide the information service. The communication network is not limited to the Internet 4, and may be an independent communication network such as an intranet set in a corporate network or a hospital.

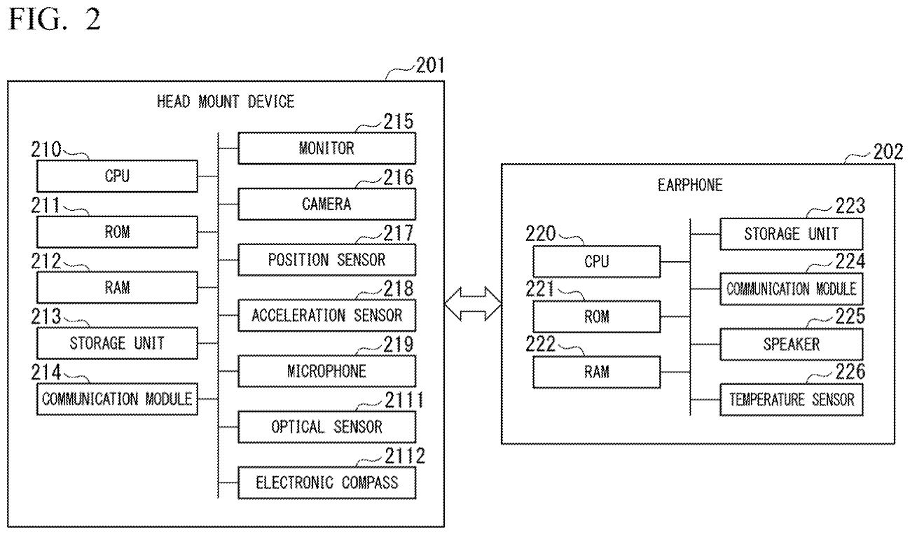

FIG. 2 is a diagram showing a hardware configuration of a wearable terminal.

More specifically, the wearable terminal 2 is a head mount device 201 or earphone 202. The head mount device 201 may include a camera for imaging what is in front of the user who is a disabled person, a position sensor, an acceleration sensor, a microphone, an optical sensor, and the like. The earphone 202 outputs voice information output from the guidance device 1.

More specifically, the head mount device 201 of the wearable terminal 2 includes a CPU (Central Processing Unit) 210, a ROM (Read Only Memory) 211, a RAM (Random Access Memory) 212, a storage unit 213, a communication module 214, a monitor 215, a camera 216, a position sensor 217, an acceleration sensor 218, a microphone 219, an optical sensor 2111, an electronic compass 2112, and the like. The head mount device 201 is a spectacle-type device, and so a disabled person can wear the head mount on the face like spectacles.

The head mount device 201 can transmit sensing information (information acquired by the sensor) acquired from the camera 216, the position sensor 217, the acceleration sensor 218, the microphone 219, the optical sensor 2111, the electronic compass 2112, and the like to the guidance device 1. The sensing information of the camera 216 is a still image or a moving image. The sensing information of the position sensor 217 is the user's position information. The sensing information of the accelerometer 218 is the acceleration of the user's movement. The sensing information of the microphone 219 is audio emitted in the user's surrounding environment or the user's own voice. The sensing information of the optical sensor 2111 is light generated in the user's surrounding environment. The sensing information of the electronic compass 2112 is an orientation such as the user's viewing direction. These pieces of sensing information are sensing information in the user himself or in the user's surrounding environment.

The earphone 202 of the wearable terminal 2 may include a CPU (Central Processing Unit) 220, a ROM (Read Only Memory) 221, a RAM (Random Access Memory) 222, a storage unit 223, a communication module 224, a speaker 225, and a temperature sensor 226. As an example, the earphone 202 may be a device that communicates with the head mount device 201 and outputs voice information transmitted from the head mount device 201 from the speaker 225. For example, the guidance device 1 transmits voice information, which is one of the pieces of guidance information, to the head mount device 201. The head mount device 201 transfers the voice information to the earphone 202. The earphone 202 outputs a voice based on the voice information transferred from the head mount device 201 from the speaker 225. The temperature sensor 226 may measure the body temperature of the user and may transmit sensing information indicating the body temperature to the guidance device 1 via the head mount device 201. The guidance device 1 may generate guidance information based on the body temperature of the user.

The guidance device 1 may directly transmit guidance information to the head mount device 201 or the speaker 225. Alternatively, the guidance device 1 may transmit guidance information to a mobile terminal held by a disabled person, and the mobile terminal may then transfer the guidance information to the head mount device 201 or the speaker 225. In the present example embodiment, the case where the device that transmits the sensing information to the guidance device 1 is the head mount device 201 of the wearable terminal 2 will be described as an example, but the device that transmits the sensing information to the guidance device 1 may be the earphone 202 or another device such a mobile terminal.

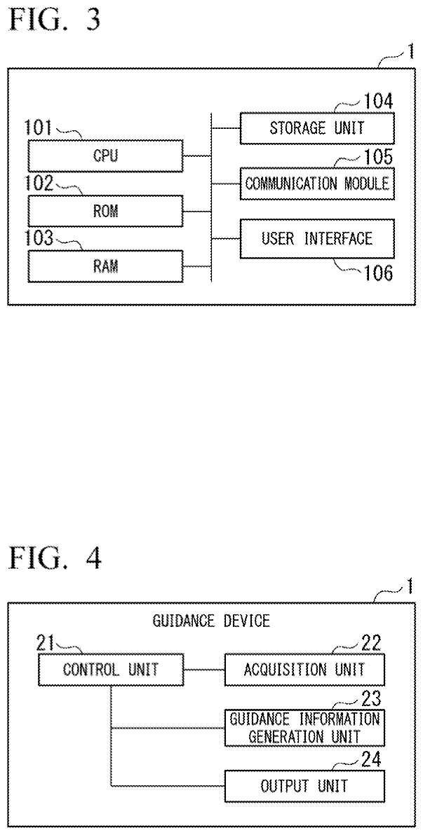

FIG. 3 is a diagram showing the hardware configurations of the guidance device, the external device, and the mobile terminal.

The guidance device 1, the external device 3, and the mobile terminal 5 each is a computer including hardware such as a CPU (Central Processing Unit) 101, a ROM (Read Only Memory) 102, a RAM (Random Access Memory) 103, a storage unit 104, a communication module 105 (appropriately called a communication unit), and a user interface 106. The guidance device 1 and the external device 3 may internally or externally including a database as the storage unit 104.

FIG. 4 is a function block diagram of the guidance device.

The guidance device 1 executes a guidance program stored in advance. As a result, the guidance device 1 exhibits the functions of a control unit 21, an acquisition unit 22, a guidance information generation unit 23, and an output unit 24.

The control unit 21 controls other function units of the guidance device 1.

The acquisition unit 22 acquires the sensing information of the user's surrounding environment acquired from the wearable terminal 2 worn on the user's body.

The guidance information generation unit 23 generates guidance information for the user based on the sensing information of the surrounding environment and the type of disability of the user. The type of disability is not limited to the type of disability, and may be information indicating the severity of disability, the degree of disability, the grade of disability, and the like.

The output unit 24 transmits the guidance information to the wearable terminal 2 or the mobile terminal 5, which is the output destination.

The external device 3 is, for example, a computer device that provides a map service, providing the output of map information indicating a map in the vicinity of a position specified by the user, and output of a movement route from the user's current position to a position specified by the user, and the like. As another example, the external device 3 is a computer device that provides a vehicle transfer guidance service, outputting vehicle routes to a destination specified by a user, transfer points, and transfer times. As another example, the external device 3 may be a computer device that provides a service such as output of weather information at locations where users are present today (currently) and in the future.

The guidance device 1 of the present example embodiment having the above-described configuration generates the guidance information according to the type of disability on the basis of a comparison between past captured images specified by the user's position and the user's estimated recognition direction and images of estimated recognition direction with the user serving as a reference.

The guidance device 1 generates guidance information further on the basis of the destination and map information acquired from outside.

The guidance device 1 generates guidance information further on the basis of the destination and a route search result acquired from outside.

The guidance device 1 generates guidance information further on the basis of target information regarding the target of the destination input in advance by a user operation.

The guidance device 1 generates guidance information further on the basis of the information pertaining to the output destination input in advance by a user operation.

The guidance device 1 acquires sensing information that is sensing information of the user's surrounding environment acquired from the wearable terminal 2, and includes at least the user's position, the user's estimated recognition direction, and an image in the estimated recognition direction with the user serving as a reference (an image obtained by pointing the camera in the estimated recognition direction at the user's position), and generates guidance information for the user on the basis of the user's position, the user's estimated recognition direction (the direction which the user is estimated to be facing), and an image in the estimated recognition direction with the user as serving a reference.

The guidance device 1 according to the present example embodiment, by including the above-mentioned configuration, outputs information guiding a disabled person with higher accuracy to the wearable terminal 2 serving as an output destination or the mobile terminal 5 held by a family member assisting the disabled person.

### First Example Embodiment

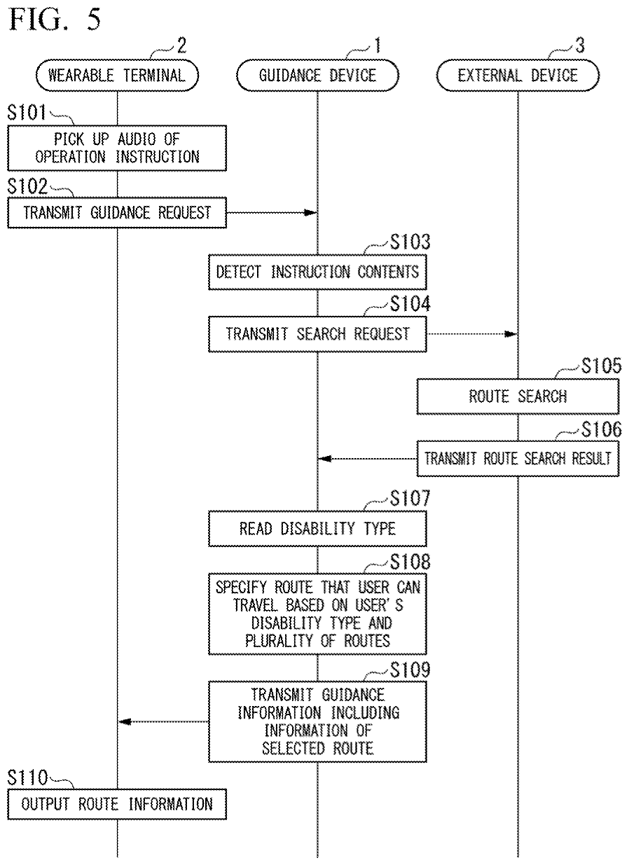

FIG. 5 is a diagram showing the processing flow of the guidance system according to the first example embodiment.

An example is shown of the case of the guidance system 100 of the first example embodiment guiding a disabled user wearing the wearable terminal 2 to a destination designated by the user.

First, in order to register the destination in the guidance device 1, the user utters an operation instruction including words indicating “guidance start” and “destination (destination name)”. The microphone 219 of the head mount device 201 picks up the audio of the user's operation instruction (Step S101). The microphone 219 of the head mount device 201 outputs the user's audio data to the CPU 210. The CPU 210 acquires the user's position information from the position sensor 217. The CPU 210 generates a guidance request including audio data, location information, and a user ID (user identifier). The CPU 210 outputs the guidance request to the communication module 214. The communication module 214 transmits the user's guidance request to the guidance device 1 (Step S102). Registration of the destination in the guidance device 1 is not limited to instructions by voice. Registration of the destination to the guidance device 1 may be executed by the guidance device 1 detecting any action for notifying the intention of the user. For example, in the case of a user who has difficulty speaking, the destination may be registered in the guidance device 1 by the operation of the user pressing a button for which the destination has been set in advance, or the destination may be registered in the guidance device 1 by the user inputting the destination using a keyboard.

The guidance device 1 receives the guidance request from the user. The acquisition unit 22 of the guidance device 1 acquires the user ID and audio data from the guidance request, and outputs those pieces of data to the guidance information generation unit 23. The guidance information generation unit 23 analyzes the audio data to detect the instruction contents of “guidance start” and “destination (destination name)” (Step S103). The guidance information generation unit 23 determines that the external device 3 is requested to search for a route from the current position to the destination on the basis of the “guidance start” of the instruction content and the audio data. The guidance information generation unit 23 transmits a search request including the current position and the destination (destination name) to the external device 3 (Step S104). Alternatively, the guidance device 1 may determine the guidance information to be provided to the user based on the history of the past destination guidance of the user specified by the user ID. In that case, the processing of steps S104 to S106 is omitted.

The external device 3 receives the search request. The external device 3 acquires the user's current position and destination (destination name) from the search request. The external device 3 according to the present example embodiment is a computer that performs a route search to provide information on a map service and a transfer guidance service. The external device 3 receives the input of information indicating the current position and the destination (destination name), and searches for a route from the current position to the destination (Step S105). In this route search, the external device 3 calculates one or a plurality of routes from the current position to the position indicated by the destination (destination name). The external device 3 transmits the route search result including one or a plurality of routes to the guidance device 1 (Step S106).

The guidance device 1 receives the route search result. The guidance information generation unit 23 acquires information on the route to one or more destinations from the route search result. The guidance information generation unit 23 reads the disability type of the user stored in advance based on the user ID (Step S107). When the guidance information generation unit 23 can acquire a plurality of route information, the guidance information generation unit 23 specifies a route that the user can travel from among the plurality of routes based on the user's disability type and the plurality of routes (Step S108). When the guidance information generation unit 23 acquires only the information of one route, the guidance information generation unit 23 specifies that route.

For example, when the user's disability type indicates wheelchair use, and there are route with stairs among the routes included in the route search result, the guidance information generation unit 23 selects the route with the shortest travel time from the routes not including stairs in the routes. Specifically, the route information includes the type of each section in the route, with the type indicating a walking section, a stairs section, a train section, and the like, and the guidance information generation unit 23 determines whether, among those types, there is an inappropriate type of route based on the disability type, and selects a route that does not include a section of the inappropriate type.

For example, when the user's disability type indicates visual impairment, and a walking section (route) greater than a specified time, such as a walking time of 5 minutes or more, is included in the routes included in the route search result, the guidance information generation unit 23 may select a route in which that walking section becomes a bus movement section.

The guidance information generation unit 23 may use a route selection model generated on the basis of machine learning to select one optimal route on the basis of the disability type of the user and information of the route included in the route search result.

The guidance information generation unit 23 may select the optical route on the basis of the route information used for the user's past movement to the same destination and the route information newly included in the route search result this time. For example, if the travel time per unit distance between predetermined points on a route included in the information of the route used for traveling to the same destination in the past is equal to or longer than a predetermined threshold value, since it is possible to ascertain that time would be required for moving due to the use of that route, another route may be selected. For example, when specifying a route that the user can travel, the guidance information generation unit 23 may add and specify other information possessed by the guidance device 1. The other information includes the weather in the area where the user will travel (including information such as rainfall, snowfall, and lightning), information about the aisle width of the route the user will travel (including the width of aisles where a wheelchair can pass), and presence of blocks for guiding visually impaired people on the route the user will travel, operation information of public transportation, and the like.

The guidance information generation unit 23 transmits the guidance information including information of the selected route to the user's head mount device 201 (Step S109). The guidance information generation unit 23 may specify the output mode of the guidance information according to the type of disability of the user, and transmit the guidance information including that output mode to the head mount device 201. For example, the guidance information generation unit 23 specifies the output mode as the speaker 225 when the user's disability type indicates visual impairment. Alternatively, the guidance information generation unit 23 specifies the output mode as a monitor when the user's disability type indicates hearing impairment. The guidance information generation unit 23 may specify the output mode as either one or both of the speaker 225 and the monitor 215 based on other disability types of the user. The guidance information generation unit 23 generates a guidance image or a guidance text which is information indicating a route according to the specified output mode. The guidance image or guidance text may be information that the external device 3 stored in the route search result and transmitted to the guidance device. In this case, the guidance information generation unit 23 may acquire the guidance image or the guidance text included in the route search result, select either one or both on the basis of the specified output mode, generate the guidance information including at least one of the guidance image or the guidance text, and transmit the guidance information to the head mount device 201.

The head mount device 201 receives the guidance information. The CPU 210 of the head mount device 201 acquires an output mode from the guidance information, and outputs the route information included in the guidance information to the output destination specified by the output mode (Step S110). The route information may be a guidance image or a guidance text as described above. When the output mode is a monitor, the CPU 21 outputs a guidance image to the monitor 215. When the output mode is an earphone, the CPU 21 transmits the guidance text to the earphone 202. Upon acquiring the guidance image from the CPU 210, the monitor 215 of the head mount device 201 outputs the guidance image to the monitor 215. Thereby, the user can visually recognize the guidance image showing the route to the destination displayed on the monitor of the head mount device 201. Alternatively, when the earphone 202 has received the guidance text, a CPU 220 converts the text into audio and outputs the audio from the speaker 225. Thereby, the user can ascertain the route to the destination by the audio that was output from the earphone 202.

According to the above processing, a user with a disability can acquire guidance information according to his/her disability from an appropriate output device. Thereby, the guidance device 1 can provide guidance for the user with higher accuracy.

### Second Example Embodiment

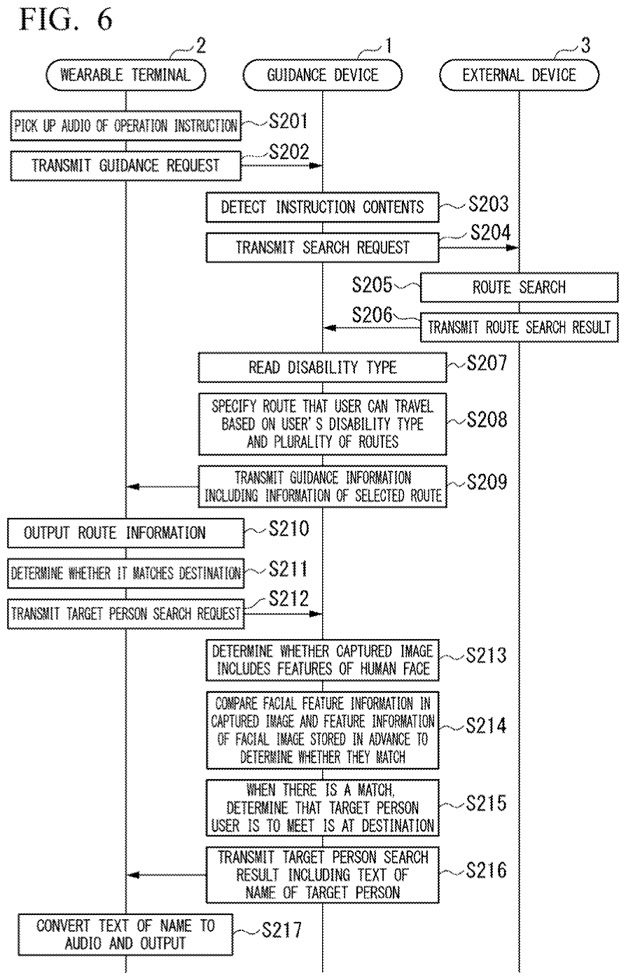

FIG. 6 is a diagram showing the processing flow of the guidance system according to the second example embodiment.

Shown is an example when the guidance system 100 of the second example embodiment assists in finding a target such as a predetermined person when a disabled user wearing the wearable terminal 2 has arrived at a destination.

First, in order to register a destination in the guidance device 1, the user utters an operation instruction including words indicating “guidance start”, “destination (destination name)”, and “target person information” to meet at the destination. The target person information is information for specifying the target person, and may be a name, a telephone number, or the like. The microphone 219 of the head mount device 201 picks up the audio of the user's operation instruction (Step S201). The microphone 219 of the head mount device 201 outputs the user's audio data to the CPU 210. The CPU 210 acquires the user's current position information from the position sensor 217.

The CPU 210 generates a guidance request including the audio data, location information, and a user ID. The CPU 210 outputs the guidance request to the communication module 214. The communication module 214 transmits the user's guidance request to the guidance device 1 (Step S202).

The guidance device 1 receives the user's guidance request. The acquisition unit 22 of the guidance device 1 acquires the user ID and audio data from the guidance request and outputs the user ID and audio data to the guidance information generation unit 23. The guidance information generation unit 23 analyzes the audio data to detect the instruction content of “guidance start”, “destination (destination name)”, and “target person information” to meet at the destination (Step S203). The guidance information generation unit 23 records the user ID included in the guidance request, the detected “destination (destination name)”, and the “target person information” to meet at the destination in the storage unit 104 in association with each other. The guidance device 1 may store a face image of the target person in advance. Alternatively, the guidance device 1 may transmit the target person information to an external database, and as a result, acquire the face image of the person indicated by the target person information from the database. The guidance information generation unit 23 records the user ID, the detected “destination (destination name)”, “target person information” to meet at the destination, and a face image in the storage unit 104 in association with each other.

The guidance information generation unit 23 determines to request the external device 3 to search for a route from the current position to the destination based on the “guidance start” of the instruction content and the audio data. The guidance information generation unit 23 transmits a search request including the current position and the destination (destination name) to the external device 3 (Step S204). Subsequent processing of the guidance device 1 and processing of the external device 3 are the same as the processing in the first example embodiment described above. That is, it is assumed that steps S205 to S210, which correspond to the similar processing of steps S105 to S110 in the first example embodiment, are performed.

The CPU 210 of the head mount device 201, upon detecting the completion of the output of the route information included in the guidance information in Step S210, determines whether the current position matches the destination that can be specified by the destination name (Step S211). The CPU 210 of the head mount device 201 may acquire the position information of the destination indicated by the destination name from the guidance device 1, or the position information of the destination indicated by the destination name may be included in the route search result mentioned above. The CPU 210 compares the current position with the position information of the destination, and if there is a match, the CPU 210 acquires a captured image from the camera 216. The CPU 210 transmits a target person search request including the acquired captured image and the user ID to the guidance device 1 (Step S212). The CPU 210 of the head mount device 201 transmits a target person search request to the guidance device 1 at a predetermined interval, such as every second.

The guidance device 1 receives the target person search request. The acquisition unit 22 of the guidance device 1 acquires the user ID and the captured image included in the target person search request and outputs both to the guidance information generation unit 23. The guidance information generation unit 23 determines whether or not the captured image includes features of a human face (Step S213). When the captured image includes features of a human face, the guidance information generation unit 23 generates feature information of that face. The guidance information generation unit 23 specifies the user ID included in the target person search request, and reads the face image stored in the storage unit 104 in association with the user ID. The guidance information generation unit 23 compares the facial feature information in the captured image acquired from the head mount device 201 with facial feature information stored in advance, and determines whether there is a match (Step S214).

When the facial feature information in the captured image acquired from the head mount device 201 and the facial feature information stored in advance match, the guidance information generation unit 23 determines that the target person whom the user is to meet is at the destination (Step S215). Upon determining that the target person whom the user is to meet is at the destination, the guidance information generation unit 23 reads the name of the target person information stored in association with the user ID. The guidance information generation unit 23 transmits the target person search result including the text of the name of the target person whom the user is to meet to the head mount device 201 (Step S216). When the user's disability type indicates visual impairment, the guidance information generation unit 23 transmits the target person search result including the text of the name and information of the earphone as the output mode to the head mount device 201.

The head mount device 201 receives the target person search result. The CPU 210 of the head mount device 201 acquires the output mode from the target person search result, and outputs the target person information included in the target person search result to the output destination specified by the output mode. The target person information may be text data of the name as described above. When the output mode is the earphone, the CPU 21 transmits the text data of the name of the target person to the earphone 202. When the earphone 202 has received the text of the name, the CPU 220 converts the text of the name into audio and outputs the name of the target person by audio from the speaker 225 (Step S217). As a result, the user can ascertain that the target person to be met is nearby by the audio that is output from the earphone 202.

In the past, visually impaired users, even when they arrived at their destination, were uncertain whether the person they intended to meet was at that location. However, according to the above-mentioned processing, appropriate guidance information according to one's disability can be acquired from the guidance device 1, and a visually impaired user can ascertain whether or not there is a person to meet at the destination. In the present example embodiment, an example was disclosed in which the target person is specified in cooperation with the guidance device 1, but the target person may be specified only by the wearable terminal 2 using data possessed by the wearable terminal 2. In this case, steps S212 to S216 may be omitted (skipped) from the processing flow, and the target person may be specified only by the guidance device 1 in the same manner.

In the above process, the guidance device 1 may calculate the distance from the user to the target person. For example, the guidance information generation unit 23 estimates the distance to the target person indicated by the face image on the basis of the size of the face image that appears in the captured image, and transmits that distance information by adding it to the target person search result, to the wearable terminal 2. Thereby, the earphone 202 may convert information indicating the distance to the target person into audio and output the audio giving notice of the distance from the speaker 225. Further, the guidance device 1 may notify the mobile terminal 5 that the target person to meet at the destination could be identified. Alternatively, the head mount device 201 may notify the mobile terminal 5 that the target person to meet at the destination could be identified. Alternatively, the head mount device 201 may according to the instruction of the user notify the mobile terminal 5 that the target person to be met at the destination was able to be met.

### Third Example Embodiment

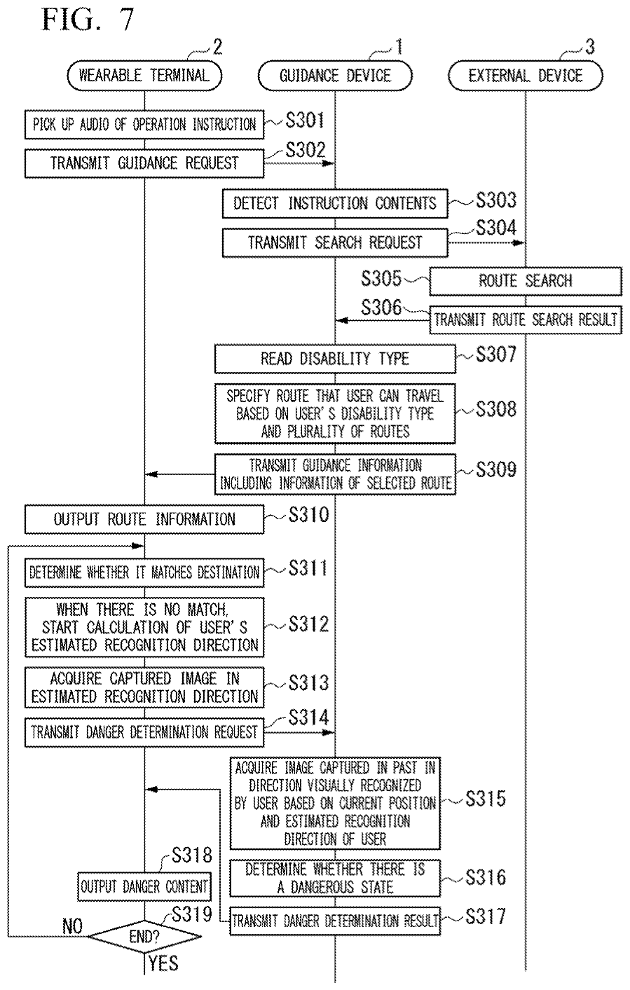

FIG. 7 is a diagram showing the processing flow of the guidance system according to the third example embodiment.

An example is shown of the case of the guidance system 100 of the third example embodiment assisting the movement of a disabled user wearing the wearable terminal 2 until arriving at a destination.

First, in order to register the destination in the guidance device 1, the user utters an operation instruction including words indicating “guidance start” and “destination (destination name)”. The microphone 219 of the head mount device 201 picks up the audio of the user's operation instruction (Step S301). The microphone 219 of the head mount device 201 outputs the user's audio data to the CPU 210. The CPU 210 acquires the user's current position information from the position sensor 217. The CPU 210 generates a guidance request including voice data, location information, and a user ID. The CPU 210 outputs the guidance request to the communication module 214. The communication module 214 transmits the user's guidance request to the guidance device 1 (Step S302).

The guidance device 1 receives the user's guidance request. The acquisition unit 22 of the guidance device 1 acquires the user ID and audio data from the guidance request and outputs the user ID and audio data to the guidance information generation unit 23. The guidance information generation unit 23 analyzes the audio data to detect the instruction contents of “guidance start”, “destination”, and “destination name” (Step S303).

The guidance information generation unit 23 determines that the external device 3 is requested to search for a route from the current position to the destination based on the “guidance start” of the instruction content and the audio data. The guidance information generation unit 23 transmits a search request including the current position and the destination (destination name) to the external device 3 (Step S304). Subsequent processing of the guidance device 1 and processing of the external device 3 are the same as the processing of the first example embodiment described above. That is, it is assumed that steps S305 to S310, which correspond to the similar processing of steps S105 to S110 in the first example embodiment, are performed.

The CPU 210 of the head mount device 201, upon detecting the completion of the output of the route information included in the guidance information in step S310, determines whether the current position matches the destination that can be specified by the destination name (Step S311). The CPU 210 of the head mount device 201 may acquire the position information of the destination indicated by the destination name from the guidance device 1, or the position information indicating the position of the destination indicated by the destination name may be included in the above-mentioned route search result. The CPU 210 compares the current position with the position of the destination, and if the positions do not match, starts calculating the estimated recognition direction of the user (Step S312).

The estimated recognition direction is the direction in which the user is moving or the direction in which the user is facing. For example, the CPU 210 specifies the estimated recognition direction of the user wearing the device based on information indicating the north direction with respect to the device acquired from the electronic compass 2112. The estimated recognition direction coincides with the direction of the face of the user wearing the head mount device 201. Alternatively, the CPU 210 specifies the moving direction of the user wearing the head mount device 201 based on a transition of the position (latitude, longitude) acquired from the position sensor 217. The moving direction is one aspect of the user's estimated recognition direction. When calculating the estimated recognition direction, the CPU 210 acquires a captured image in the estimated recognition direction taken at that time from the camera 216 (Step S313). The CPU 210 generates a danger determination request including the calculated estimated recognition direction, a captured image acquired at the time of the calculation, the current position, and the user ID, and transmits the danger determination request to the guidance device 1 (Step S314). The CPU 210 generates a danger determination request at a predetermined interval such as every second, and transmits the danger determination request to the guidance device 1.

The guidance device 1 receives the danger determination request. The acquisition unit 22 acquires the estimated recognition direction, the captured image in that direction, and the current position of the user from the danger determination request, and outputs the information to the guidance information generation unit 23. The database of the guidance device 1, which is associated with the position information, stores a captured image of the surroundings having the position indicated by the position information as the origin. The guidance information generation unit 23 acquires images captured in the past in the direction visually recognized by the user from the database based on the current position of the user and the estimated recognition direction (Step S315). The guidance information generation unit 23 compares the currently captured image in the estimated viewing direction with an image captured in the past to determine whether or not there is a dangerous state (Step S316).

For example, the guidance information generation unit 23 compares the currently captured image in the estimated viewing direction with a past captured image, and specifies an image range of a danger determination target that appears in the currently captured image in the estimated viewing direction, but does not appear in the past captured image. The guidance information generation unit 23 identifies an object indicated by that image range on the basis of the image range of the danger determination target. For example, when the object included in the image range of the danger determination target is a car, the guidance information generation unit 23 can determine that a car is approaching the user. Alternatively, when the object included in the image range of the danger determination target is a fence, the guidance information generation unit 23 can determine that a fence that did not exist in the past has been installed along the road. The guidance information generation unit 23 may specify what objects are included in the image range of the danger determination target by inputting the image information of the image range into a determination model determined by machine learning. When the specified object is determined to be dangerous, the guidance information generation unit 23 generates a danger determination result including information such as the name of the object. The guidance information generation unit 23 transmits the danger determination result to the head mount device 201 (Step S317). Further, the guidance device 1 may notify the mobile terminal 5 of the danger determination result according to the content of the danger determination result. By notifying the mobile terminal 5 of the danger determination result, the person in the position of protecting the user can accurately ascertain the danger faced by the user and take appropriate measures.

Note that the guidance information generation unit 23 may specify the output mode of the danger determination result according to the disability type of the user, and transmit the danger determination result including that output mode to the head mount device 201. For example, the guidance information generation unit 23 specifies the output mode as the speaker 225 when the user's disability type indicates visual impairment. The guidance information generation unit 23 generates text that is information indicating the danger content according to the specified output mode. The text is, for example, text information indicating the name of the object included in the image range of the danger determination target specified by the guidance information generation unit 23. The guidance information generation unit 23 may generate a danger determination result including information indicating the danger content and transmit the danger determination result to the head mount device 201.

The head mount device 201 receives the danger determination result. The CPU 210 of the head mount device 201 acquires the output mode from the danger determination result, and outputs the danger content included in the danger determination result to the output destination specified by the output mode (Step S318). When the output mode is the earphone, the CPU 21 transmits text indicating the danger content to the earphone 202. When the earphone 202 receives the text indicating the dangerous content, the CPU 220 converts the text into audio and outputs the dangerous content by audio from the speaker 225. As a result, the user can ascertain whether or not he/she is facing a danger by the audio output from the earphone 202. Further, the head mount device 201 may notify the mobile terminal 5 of the danger determination result in accordance with the content of the danger determination result. Alternatively, the head mount device 201 may notify the mobile terminal 5 of the danger determination result in accordance with the content of the danger determination result by an instruction of the user. By notifying the mobile terminal 5, a person in a position of protecting the user can accurately ascertain the danger faced by the user and take appropriate measures.

If it is determined that the user is facing a danger, the head mount device 201 may stop the processing of the guidance system according to the third example embodiment and start a pre-programmed process. Alternatively, the head mount device 201 may at the instruction of the user stop the processing of the guidance system according to the third example embodiment and start the pre-programmed process. The pre-programmed process includes notification to the mobile terminal 5, a rescue request from the head mount device 201 to people in the vicinity depending on the type of danger, connection to an emergency call receiving organization such as the police, and the like.

The above process is repeated from the time the user starts moving until arrival at the destination. Specifically, the head mount device 201 or the like, which is a wearable terminal, determines whether to end the process (Step S319), and if not, repeats the processes of steps S311 to S317.

It has conventionally been difficult for visually impaired users to detect danger while moving to a destination. However, according to the above-mentioned processing, appropriate guidance information according to one's disability can be acquired from the guidance device 1, and a visually impaired user can easily detect danger while moving to a destination.

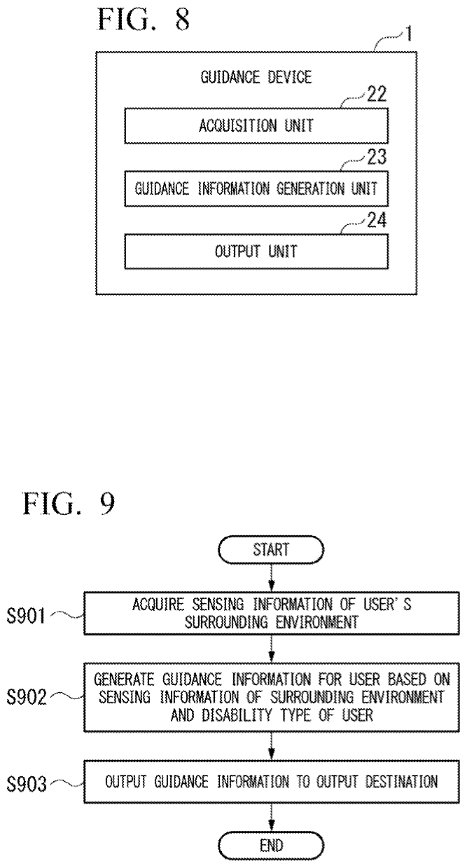

FIG. 8 is a diagram showing a guidance device according to another example embodiment.

FIG. 9 is a diagram showing a first processing flow by the guidance device shown in FIG. 8.

As shown in FIG. 8, the guidance device 1 includes at least an acquisition unit, a guidance information generation unit, and an output unit.

The acquisition unit 22 acquires the sensing information of the user's surrounding environment acquired from the wearable terminal 2 worn on the user's body (Step S901).

The guidance information generation unit 23 generates guidance information for the user on the basis of the sensing information of the surrounding environment and the disability type of the user (Step S902).

The output unit 24 outputs the guidance information to the output destination (Step S903).

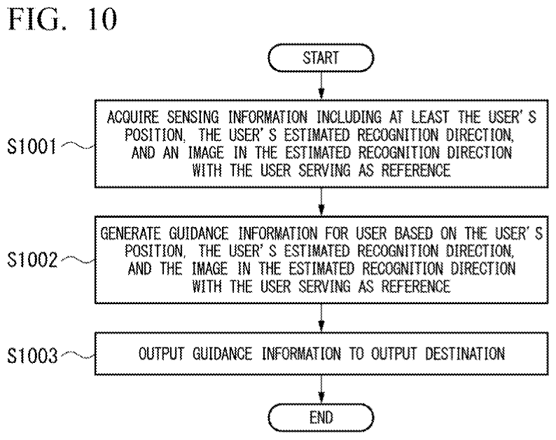

FIG. 10 is a diagram showing a second processing flow by the guidance device shown in FIG. 8.

In the guidance device 1 shown in FIG. 8 above, the acquisition unit 22 acquires sensing information, which is sensing information of the user's surrounding environment acquired from the wearable terminal worn on the user's body, and includes the user's position, the user's estimated recognition direction, and an image in the estimated recognition direction with the user serving as a reference (Step S1001).

The guidance information generation unit 23 generates guidance information for the user on the basis of the position of the user, the estimated recognition direction of the user, and the image in the estimated recognition direction with the user as a reference (Step S1002).

The output unit 24 outputs the guidance information to the output destination (Step S1003).

Each of the above-mentioned devices has a computer system therein. The process of each process described above is stored in a computer-readable recording medium in the form of a program, and the process is performed by the computer reading and executing this program. Here, the computer-readable recording medium refers to a magnetic disk, a magneto-optical disk, a CD-ROM, a DVD-ROM, a semiconductor memory, or the like. This computer program may be distributed to the computer via a communication line, and the computer receiving the distribution may execute the program.

The above program may be for realizing some of the above-mentioned functions. Furthermore, the program may be a so-called differential file (differential program) that can realize the above-mentioned functions in combination with a program already recorded in the computer system.

This application is based upon and claims the benefit of priority from Japanese patent application No. 2019-185117, filed Oct. 8, 2019, the disclosure of which is incorporated herein in its entirety by reference.

### INDUSTRIAL APPLICABILITY

The present invention may be applied to a guidance device, a guidance method, and a recording medium.

### DESCRIPTION OF REFERENCE SYMBOLS

1: Guidance device
2: Wearable terminal
3: External device
4: Internet
5: Mobile terminal
201: Head mount device
202: Earphone
21: Control unit (control means)
22: Acquisition unit (acquisition means)
23: Guidance information generation unit (guidance information generation means)
24: Output unit (output means)

What is claimed is:

1. A guidance device comprising:
at least one memory configured to store instructions; and
at least one processor configured to execute the instructions to:
acquire sensing information pertaining to a surrounding environment of a user, the sensing information being acquired from a wearable terminal worn on the user;
generate guidance information pertaining to guidance for the user based on the sensing information and a type of disability of the user; and
output the guidance information.

2. The guidance device according to claim 1, wherein
the sensing information includes a position of the user, an estimated recognition direction of the user, and an image in the estimated recognition direction captured at the position of the user, and
the at least one processor is configured to execute the instructions to generate the guidance information for the user based on the position of the user, the estimated recognition direction of the user, the image, and the type of disability.

3. The guidance device according to claim 1, wherein the at least one processor is configured to execute the instructions to generate the guidance information in accordance with the type of disability based on a comparison between an image captured in past specified by the positon of the user and the estimated recognition direction of the user, and a current image in the estimated recognition direction captured at the position of the user.

4. The guidance device according to claim 1, wherein the at least one processor is configured to execute the instructions to generate the guidance information based further on a destination and map information acquired from outside.

5. The guidance device according to claim 1, wherein the at least one processor is configured to execute the instructions to generate the guidance information based further on a destination and a route search result acquired from outside.

6. The guidance device according to claim 1, wherein the at least one processor is configured to execute the instructions to generate the guidance information based further on target information pertaining to a target designated by the user.

7. The guidance device according to claim 1, wherein the at least one processor is configured to execute the instructions to generate the guidance information based further on information pertaining to an output destination of the guidance information designated by the user.

8. A guidance device comprising:
at least one memory configured to store instructions; and
at least one processor configured to execute the instructions to:
acquire sensing information pertaining to a surrounding environment of a user, the sensing information being acquired from a wearable terminal worn on the user, the sensing information including at least a position of the user, an estimated recognition direction of the user, and a current image in the estimated recognition direction captured at the position of the user;
generate guidance information pertaining to guidance for the user based on the position of the user, the estimated recognition direction of the user, and the image; and
output the guidance information.

9. A guidance method comprising:
acquiring sensing information pertaining to a surrounding environment of a user, the sensing information being acquired from a wearable terminal worn on the user;
generating guidance information pertaining to guidance for the user based on the sensing information and a type of disability of the user; and
outputting the guidance information.

10. (canceled)
